(19) United States
(12) Patent Application Publication
(10) Pub. No.: US 2010/0170529 A1
(43) Pub. Date: Jul. 8, 2010

(54) Acoustic Cleaning Device and Method

(76) Inventors: Peter Stencel, Rowlett, TX (US); Rickey White, Lamcaster, TX (US)

Correspondence Address: Garlitz Bell, LLP, 3010 LBJ Frwy, Suite 990, Dallas, TX, 75234, US

(21) Appl. No.: 12/683,418

(22) Filed: Jan. 6, 2010

Related U.S. Application Data
(60) Provisional application No. 61/142,686, filed on Jan. 6, 2009.

(51) Int. Cl. B08B 3/12

(52) U.S. Cl. 134/1; 134/184

(57) ABSTRACT

An acoustic cleaning device and method for cleaning of the surfaces within a vessel is provided. The device may consist of one acoustic transducer or a series of smaller acoustic transducers mounted inside the vessel in a specific fashion in order to direct acoustic waves throughout the cleaning liquid and onto the interior surfaces of the vessel. An acoustic cavitation is produced by the pressure variations in sound waves moving through the cleaning liquid and a cleaning action is accomplished throughout the entire vessel interior. The acoustic cleaning device may be arranged in a variety of ways to accomplish the cleaning. The acoustic cleaning device may be used with a variety of chemical cleaning solutions and is ideal for particle surface contaminant removal.

This application claims the benefit under 35 U.S.C. Section 119(e) of U.S. Provisional Patent Application No. 61/142,686 filed on Jan. 6, 2009 in the United States Patent and Trademark Office entitled “Acoustic Cleaning Device and Method.”

### BACKGROUND

The disclosure relates generally to cleaning devices and methods and more specifically to an acoustic cleaning device and method for industrial equipment.

Surface fouling is a major problem in industrial equipment. Such equipment includes ozone generators, boilers, reactors, heat exchangers, furnaces (for coal, oil, waste, etc.), and the like. Typically, the equipment involves a vessel containing internal surfaces that are subjected to fouling by accumulating particulates, minerals, and other products and byproducts of chemical reactions, combustion, sedimentation, and the like. Such particulate build-up may progressively interfere with the equipment operation by reducing efficiency and throughput, and potentially causing damage.

Effective cleaning of the equipment is therefore highly desirable and is attended by a number of relevant considerations. However, often direct access to the fouled surfaces is difficult as they may be small, hard to reach, irregularly shaped, and blocked by a variety of obstacles. Additionally, often these vessels are very large and stationary and cannot be moved for the intended cleaning. Therefore, a thorough cleaning of such internal surfaces is hard to achieve. Additionally, it is desirable to minimize the length of time required for the cleaning in order to maintain operational continuity, industrial equipment downtime, safety, and related costs associated with the cleaning.

### SUMMARY

The problems presented in present cleaning devices and methods for industrial equipment are solved by the device and method of the present invention.

In accordance with one embodiment of the present invention, an acoustic cleaning device is provided. The acoustic cleaning device is used for the cleaning of the surfaces within a vessel. The acoustic cleaning device may consist of one acoustic transducer or a series of smaller acoustic transducers mounted inside the vessel in a specific fashion in order to direct acoustic waves throughout the cleaning liquid and onto the interior surfaces. An acoustic cavitation is produced by the pressure variations in sound waves moving through the cleaning liquid and a cleaning action is accomplished throughout the entire vessel interior. The acoustic cleaning device may be arranged in a variety of ways to accomplish the cleaning.

The acoustic cleaning device may be used with a variety of chemical cleaning solutions and is ideal for particle surface contaminant removal. It may also be used to increase the efficiency of chemical cleaning.

Other objects, features, and advantages of the present invention will become apparent with reference to the drawings and detailed description that follow.

### BRIEF DESCRIPTION OF THE DRAWINGS

FIG. 1 is a pictorial representation of a cross section view of the interior of a vessel with numerous compartments in accordance with an illustrative embodiment.

FIG. 2 is a pictorial representation of a front view of a vessel with numerous compartments in accordance with an illustrative embodiment.

FIG. 3A is a pictorial representation of an example of the acoustic cleaning device within a vessel in accordance with an illustrative embodiment.

FIG. 3B is a pictorial representation of an example of the acoustic cleaning device within a vessel in accordance with an illustrative embodiment.

FIG. 4A is a pictorial representation of an example of the acoustic cleaning device within a vessel in accordance with an illustrative embodiment.

FIG. 4B is a pictorial representation of an example of the acoustic cleaning device within a vessel in accordance with an illustrative embodiment.

FIG. 5 is a pictorial representation of an example of the acoustic cleaning device within a vessel in accordance with an illustrative embodiment.

FIG. 6A is a pictorial representation of an example of the acoustic cleaning device arranged for cleaning a portion of the cross-section of a vessel interior in accordance with an illustrative embodiment.

FIG. 6B is a pictorial representation of an example of the acoustic cleaning device arranged for cleaning the entire cross-section of a vessel interior in accordance with an illustrative embodiment.

FIG. 7 is a pictorial representation of an example of the acoustic cleaning device arranged for cleaning the entire cross-section of a vessel interior in accordance with an illustrative embodiment.

FIG. 8A is a pictorial representation of an example of the acoustic cleaning device arranged for cleaning a portion of the cross-section of a vessel interior in accordance with an illustrative embodiment.

FIG. 8B is a pictorial representation of an example of the acoustic cleaning device arranged for cleaning a portion of the cross-section of a vessel interior in accordance with an illustrative embodiment.

FIG. 9 is a pictorial representation of an example of the acoustic cleaning device in accordance with an illustrative embodiment.

### DETAILED DESCRIPTION

In the following detailed description of illustrative embodiments of the present invention, reference is made to the accompanying drawings that form a part hereof, and in which is shown by way of illustration specific illustrative embodiments in which the present invention may be practiced. These illustrative embodiments are described in sufficient detail to enable those skilled in the art to practice the present invention, and it is understood that other embodiments may be utilized and that logical mechanical and electrical changes may be made without departing from the scope and spirit of the present invention. To avoid detail not necessary to enable those skilled in the art to practice the present invention, the detailed description may omit certain information known to those skilled in the art. The following detailed description is, therefore, not to be taken in a limiting sense, and the scope of the present invention is defined only by the appended claims. It should be noted that the definition of “vessel” as used herein is a large container containing at least one cavity through which a liquid can move.

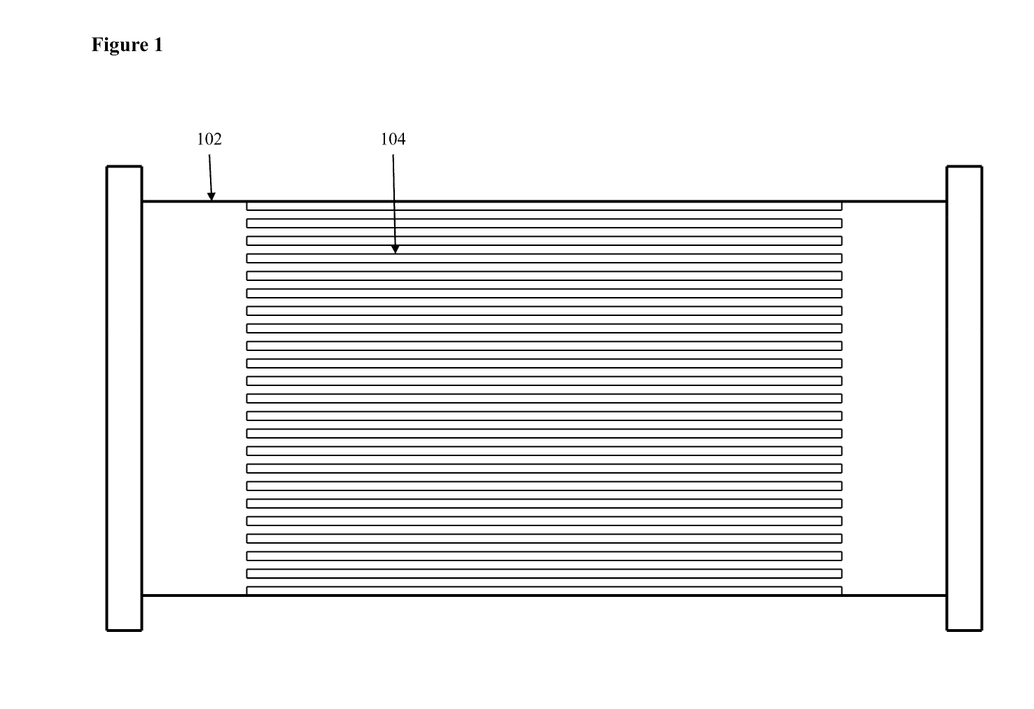

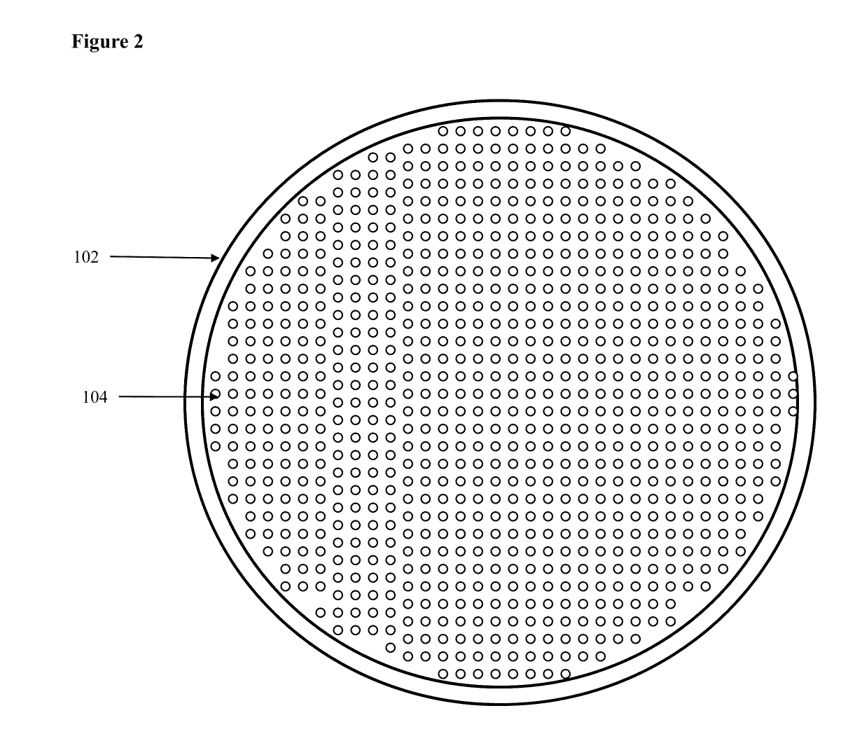

With reference now to the figures, and in particular, with reference to FIGS. 1-2, the interior of a vessel 102 with numerous hollow compartments 104 is provided as an example of the environment in which illustrative embodiments of the present invention may be implemented. It should be appreciated that FIGS. 1-2 are only exemplary and are not intended to assert or imply any limitation with regard to the environments in which different embodiments may be implemented.

FIG. 1 is a pictorial representation of a cross section view of the interior of a vessel 102 with numerous compartments 104 in accordance with an illustrative embodiment. FIG. 2 is a pictorial representation of a front view of a vessel 102 with numerous compartments 104 in accordance with an illustrative embodiment. A vessel 102 with numerous hollow compartments 104 is used in the present illustrative embodiment as the numerous hollow compartments 104 are particularly difficult to clean in an industrial setting.

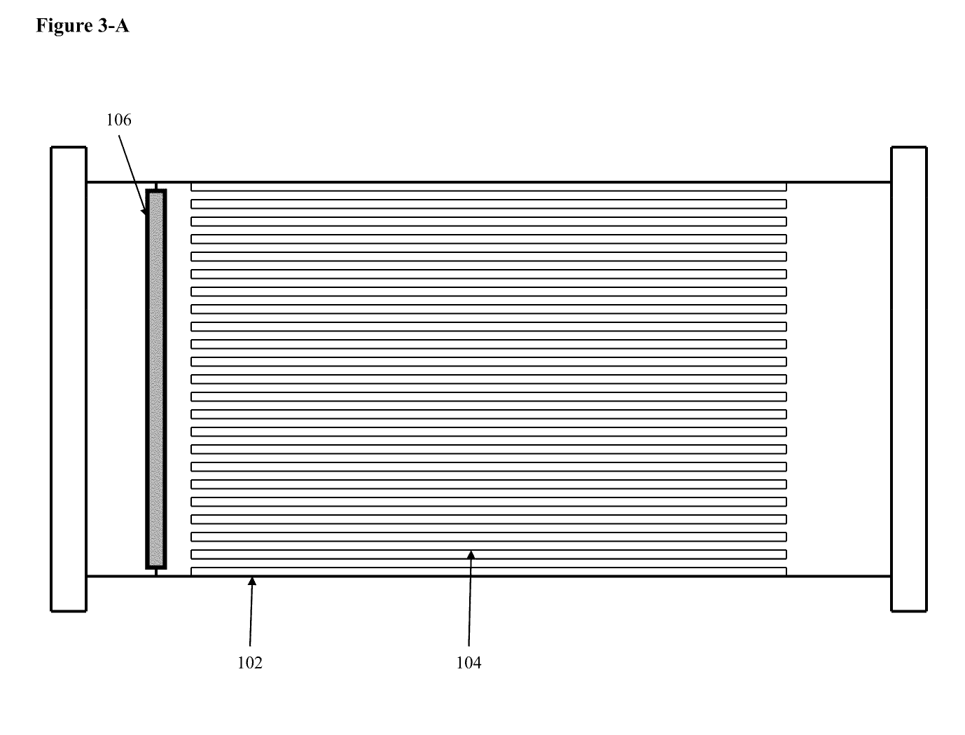

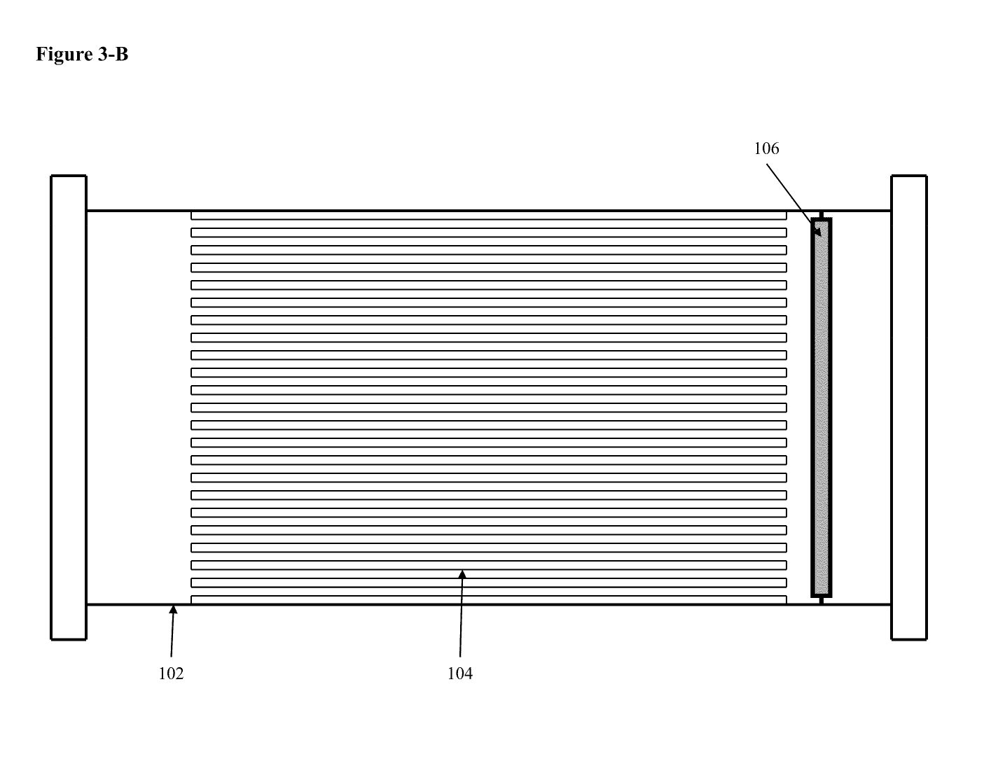

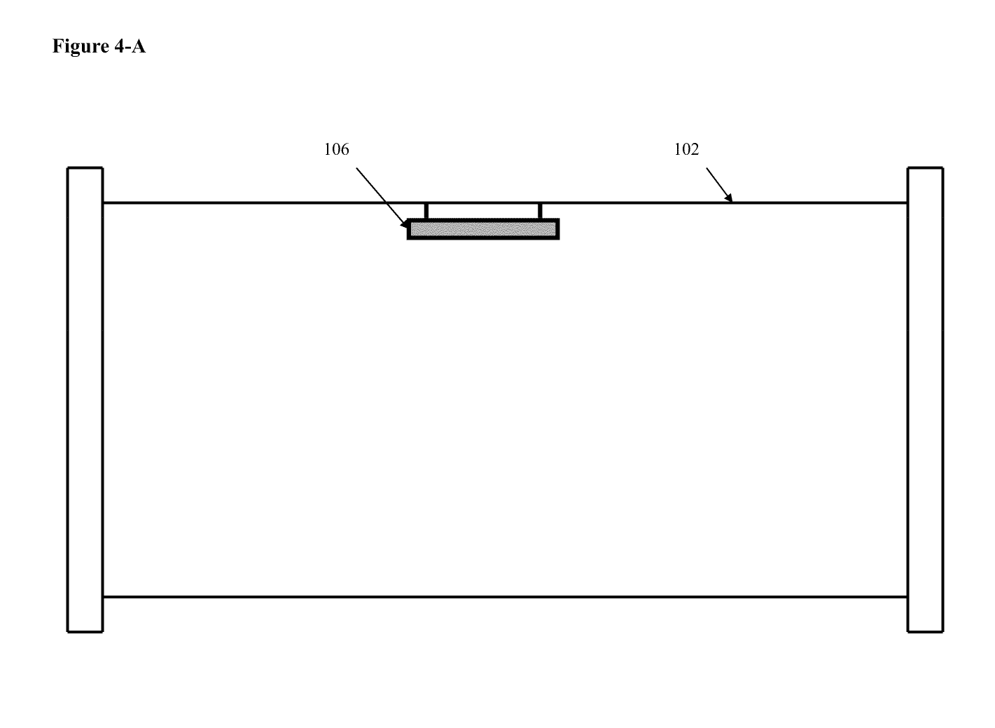

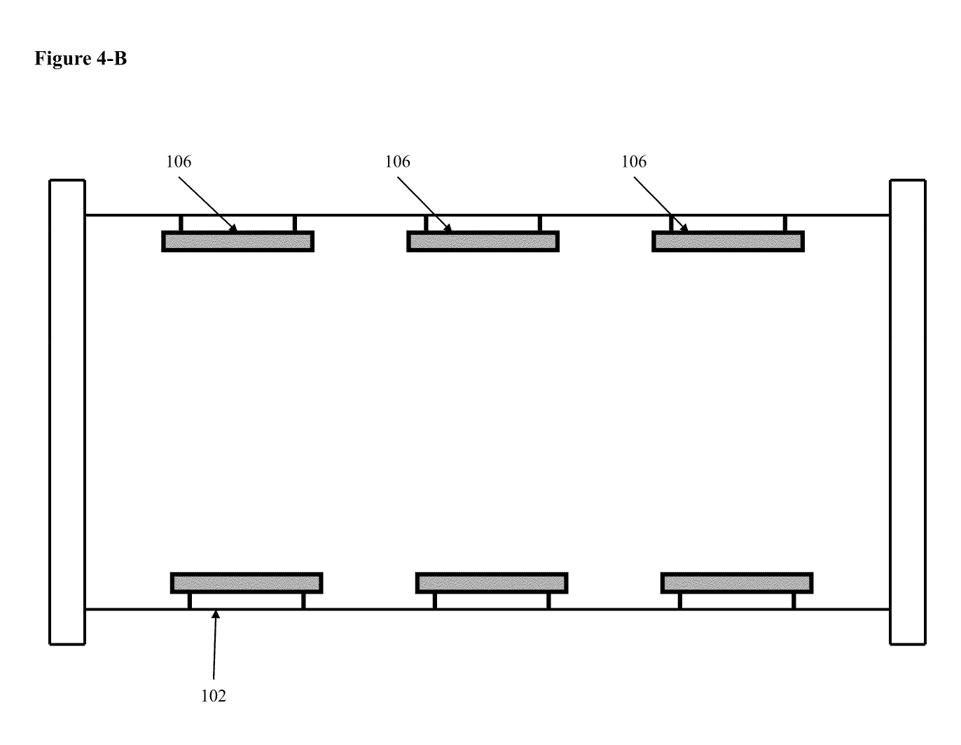

With reference now to FIGS. 3A-4B, pictorial representations of examples of the arrangement of the acoustic cleaning device 106 within a vessel 102 are depicted in accordance with illustrative embodiments. As illustrated in FIGS. 3A and 3B, the acoustic cleaning device can be located in a number of possible locations within each vessel and the location is determined based on the specifics of each particular cleaning project, the chemistries of the cleaning liquids being used, as well as the specific conditions of the vessel being cleaned. For example, in FIG. 3A, the acoustic cleaning device 106 is located in a vertical position at the proximal end of the vessel 102. In FIG. 3B, the acoustic cleaning device 106 is located at the distal end of the vessel 102.

As a further example of the various arrangements of the acoustic cleaning device 106 within a vessel 102, FIGS. 4A and 4B illustrate how the acoustic cleaning device 106 can be located in a horizontal position within a vessel 102. It should be noted that these various arrangements are for illustrative purposes only and one skilled in the art would recognize that the acoustic cleaning device may be located in a variety of positions within the vessel.

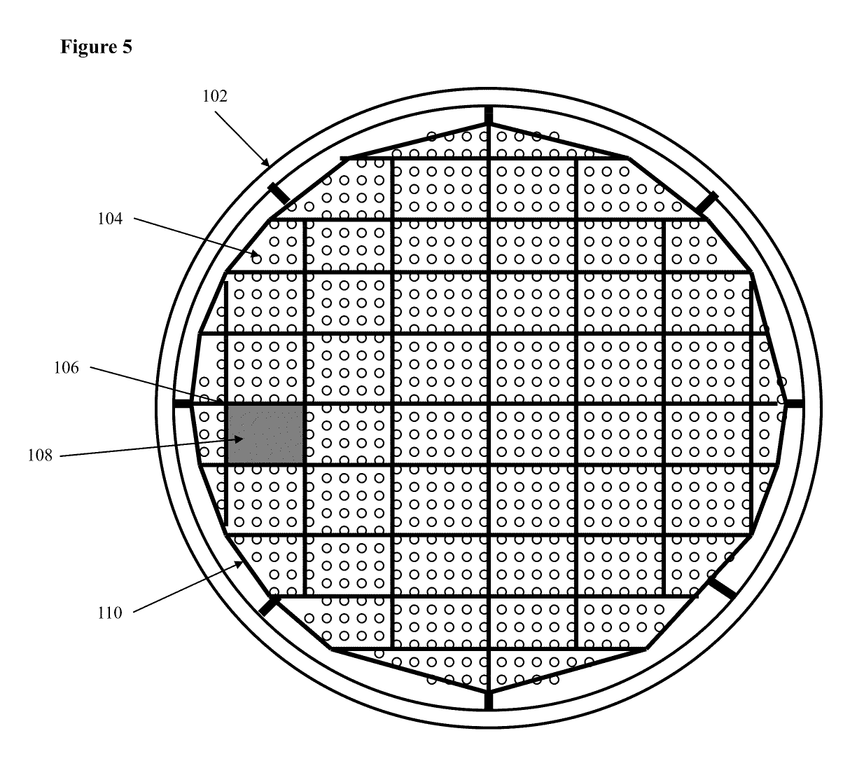

FIG. 5 illustrates the acoustic cleaning device 106 in further detail. FIG. 5 is a pictorial representation of an example of the acoustic cleaning device 106 within a vessel 102 in accordance with an illustrative embodiment. The acoustic cleaning device includes a frame 110 and an acoustic transducer 108. The frame 110 is removably fixed to the interior of the vessel 102. The acoustic transducer 108 can be attached to the frame 110 before the frame 110 is installed in the vessel 102 or the acoustic transducer 108 can be attached to the frame 110 once the frame 110 is in place inside the vessel 102.

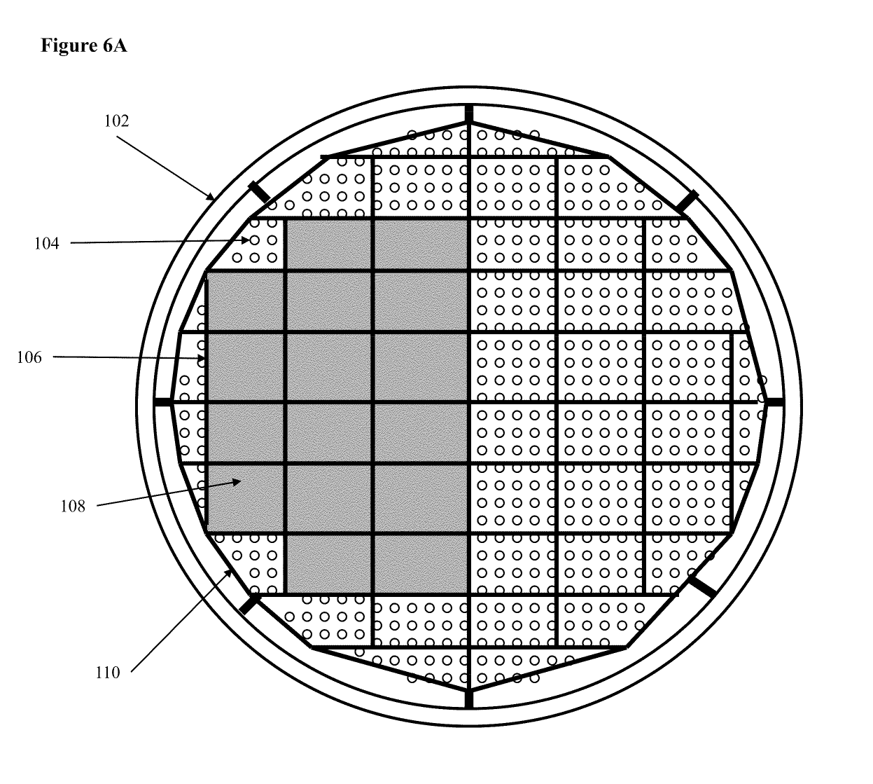

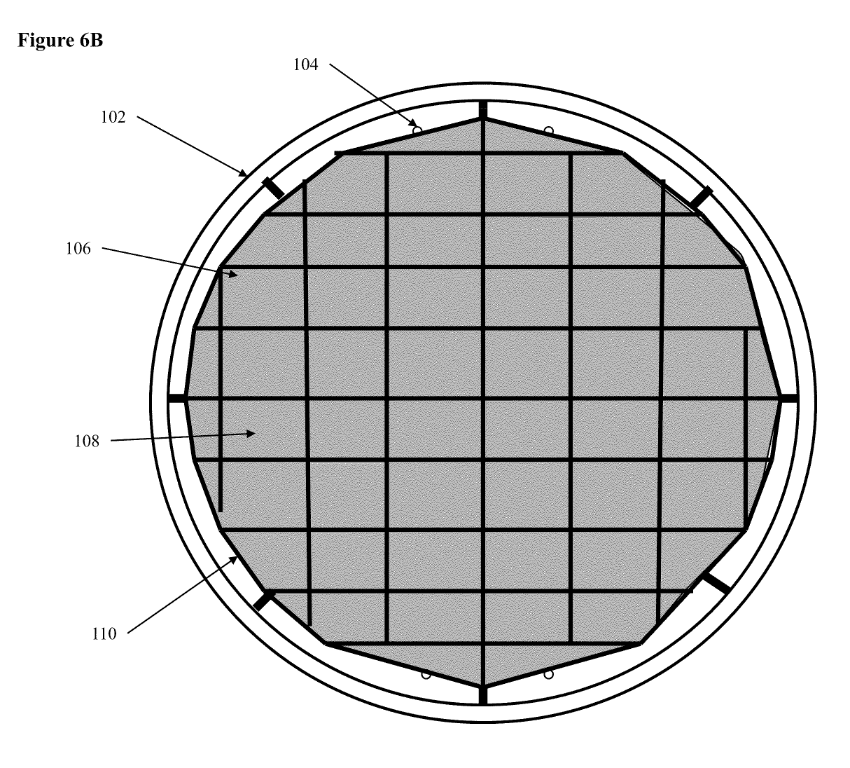

With reference now to FIGS. 6A-6B, pictorial representations of an example of the acoustic cleaning device 106 within a vessel 102 are depicted in accordance with illustrative embodiments. FIG. 6A is a pictorial representation of an example of the acoustic cleaning device 106 arranged for cleaning a portion of the cross-section of a vessel 102 interior in accordance with an illustrative embodiment. Multiple acoustic transducers 108 are attached to the frame 110 in an arrangement for the purpose of being used for cleaning a portion of the cross-section of the vessel 102 interior. FIG. 6B is a pictorial representation of an example of the acoustic cleaning device 106 arranged for cleaning the entire cross-section of a vessel 102 interior in accordance with an illustrative embodiment. Multiple acoustic transducers 108 are attached to the frame 110 in an arrangement for the purpose of being used for cleaning the entire cross-section of the vessel 102 interior. As is illustrated in FIGS. 6A and 6B, with the use of the frame 110 the acoustic transducers 108 can be arranged such that a specific portion of the vessel 102 is cleaned, such as for concentrated cleaning of a portion of the vessel 102, or the acoustic transducers 108 can be arranged such that the entire interior of the vessel 102 is cleaned.

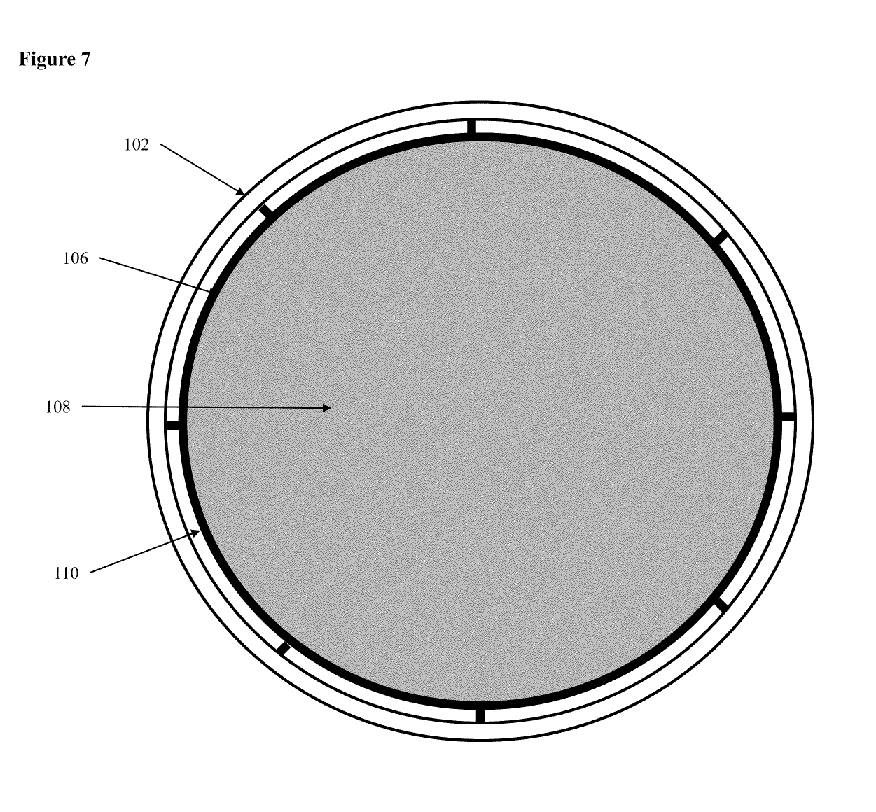

FIG. 7 is a pictorial representation of an example of the acoustic cleaning device arranged for cleaning the entire cross-section of a vessel interior in accordance with an illustrative embodiment. There is single acoustic transducer 108 supported by a frame 110, the frame 110 being removably fixed to the interior of the vessel 102, and arranged in such a manner to clean the entire cross-section of a vessel 102 interior. As is illustrated in the various Figures, the acoustic cleaning device 106 may be comprised of a single acoustic transducer 108 or multiple acoustic transducers 108. When comprised of a single acoustic transducer 108, the acoustic cleaning device 106 may be arranged such that a portion of the cross-section of a vessel 102 interior is cleaned or that the entire cross-section of a vessel 102 interior is cleaned.

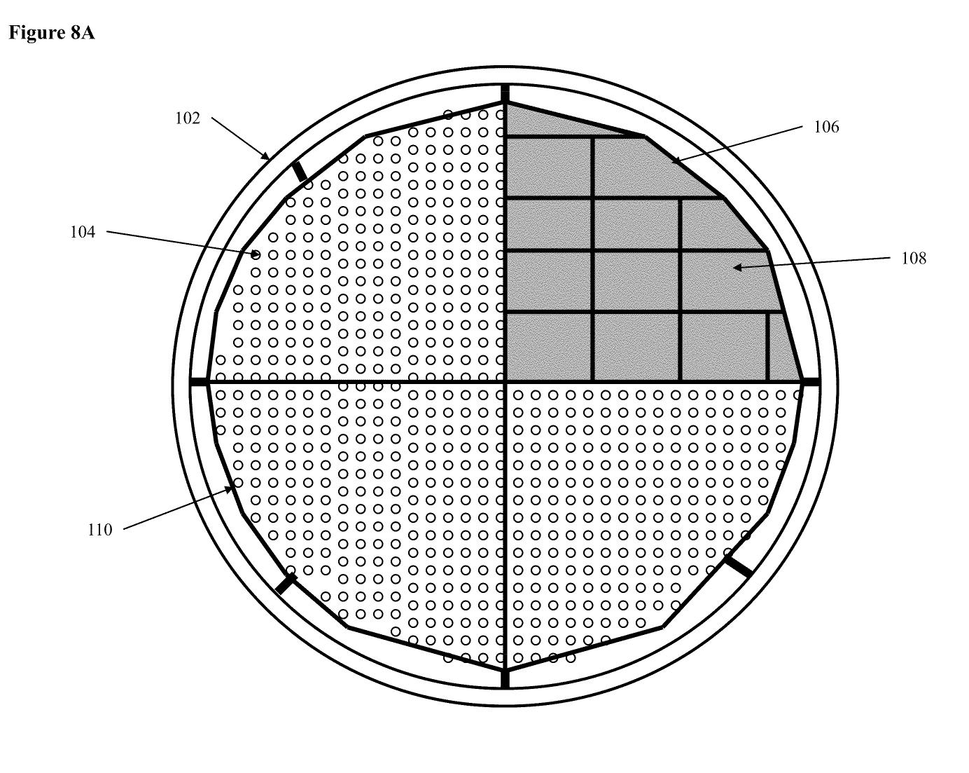

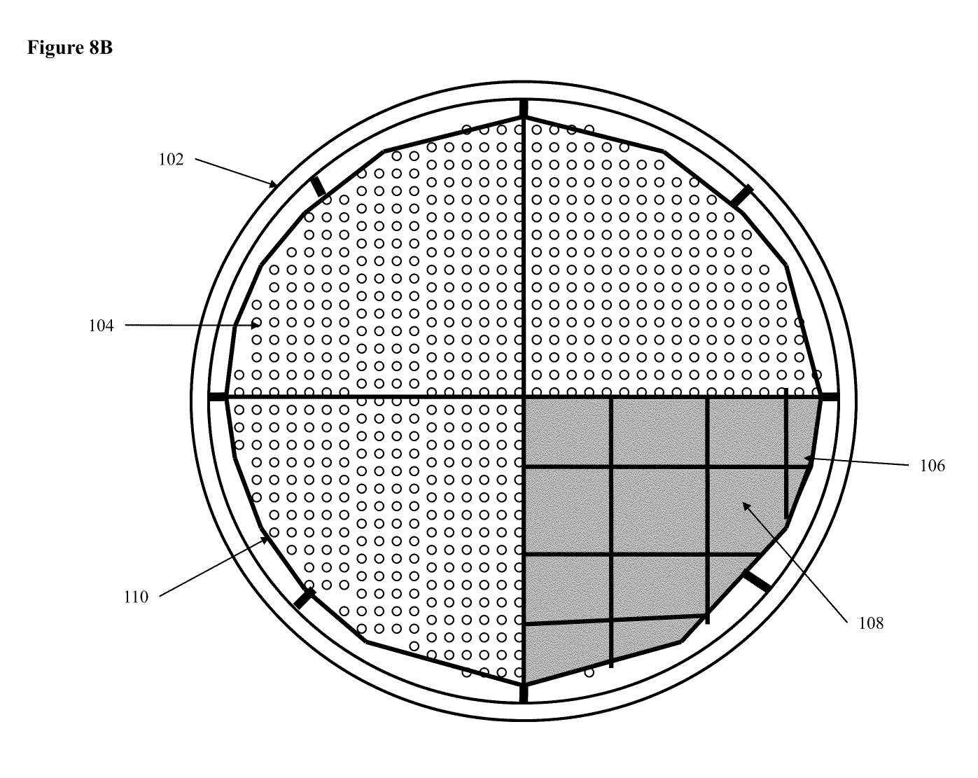

Referring now to FIGS. 8A-8B, pictorial representations of an example of the acoustic cleaning device 106 arranged for cleaning a portion of the cross-section of a vessel 102 interior are depicted in accordance with an illustrative embodiment. The acoustic cleaning device 106 includes a frame 110 and multiple acoustic transducers 108 removably fixed to the frame 110. The frame 100 is removably fixed to a vessel 102 interior. FIG. 8A shows a first position for the acoustic cleaning device 106. After the acoustic cleaning device 106 has been used to clean a portion of the cross-section of a vessel 102 interior, the acoustic cleaning device can be rotated within the vessel 102 interior to clean another portion of the cross-section of a vessel 102 interior. The frame 110 can be rotated manually within the vessel, taken out and rearranged, or moved by means of automation.

One skilled in the art will understand that the size and shape of the frame 110 can vary according to the size and the shape of the vessel 102 to be cleaned as well as the size and the shape of the acoustic transducers 108 to be attached to the frame 110. The frame 110 may be made of any material that is non-corrosive and sturdy enough to hold the acoustic transducers 108 during the cleaning process.

The acoustic transducer 108 is housed in stainless steel and includes flanges for mounting to the frame 110. The acoustic transducer 108 includes a piezoelectric driving element that is attached to a radiating diaphragm and includes electrical wiring that connects to an ultrasonic generator 116. When multiple acoustic transducers 108 are used, the electrical wiring is synchronized for enhanced performance. Electrical charge buildup in the acoustic transducer 108 is prevented by a bleed resistor wired in parallel with the driving element.

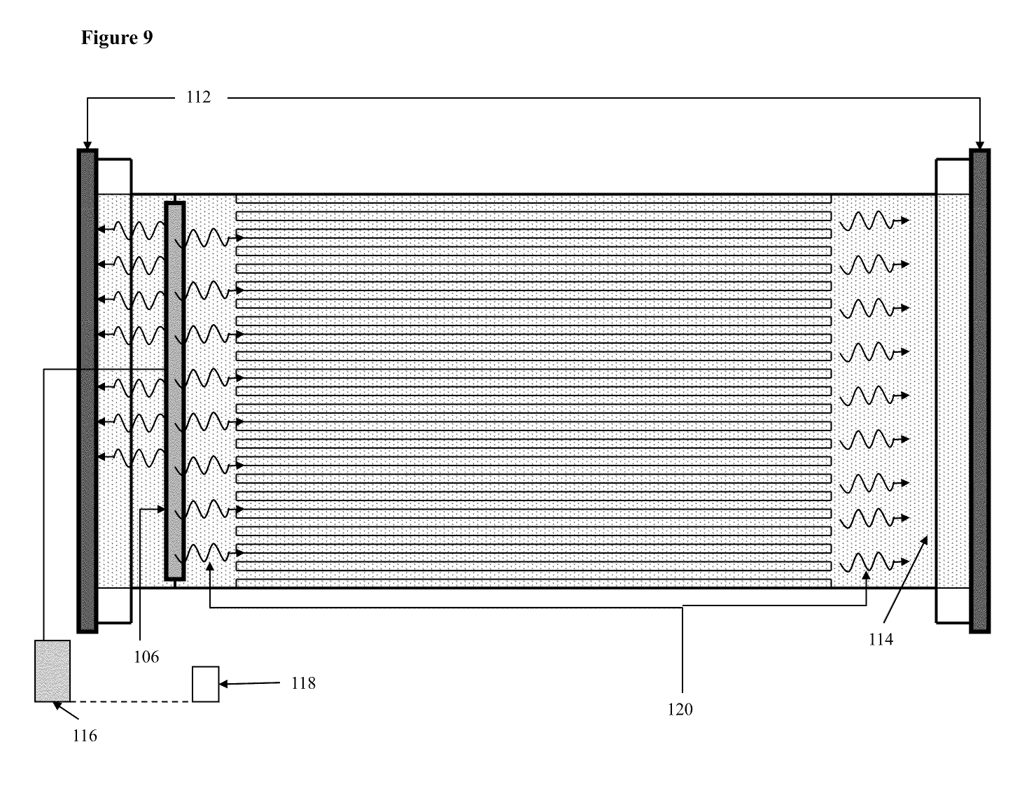

FIG. 9 is a pictorial representation of an example of the acoustic cleaning device 106 in accordance with an illustrative embodiment. The acoustic cleaning device 106 is removably fixed to the vessel 102 interior and the doors 112 of the vessel 102 are sealed such that the cleaning solution 114 will not leak from the vessel 102. One skilled in the art will understand that the vessel 102 may be sealed using the existing doors of the vessel or any closure that ensures the cleaning solution will not leak from the vessel. The vessel 102 is then filled with a cleaning solution 114. The acoustic transducer 108 within the acoustic cleaning device 106 is electrically connected to an ultrasonic generator 116 that is controlled by control system 118. The acoustic transducer 108 within the acoustic cleaning device 106 produces ultrasonic waves 120 in the cleaning solution 114 by changing size in concert with electrical signals oscillating at ultrasonic frequencies. This creates compression waves 120 in the cleaning solution 114 and this ultrasonic agitation results in a cleaning action. The ultrasonic generator 116 controls the acoustic transducer 108 within the acoustic cleaning device 106, such as power, frequencies, wavelengths, and the like. The settings of the ultrasonic generator 116 are controlled by the control system 118 so that single or multiple frequencies are used to clean the vessel 102.

The acoustic waves 120 travel throughout the vessel and create compression and expansion in the cleaning solution 114. In the compression wave 120, the molecules of the cleaning solution 114 are compressed together tightly. Conversely, in the expansion wave 120, the molecules are pulled apart rapidly. These pressure swings and the chemical action of the cleaning solution 114 provide a cleaning action throughout the vessel's 102 interior.

Any rotation or movement of the acoustic cleaning device 106 can be accomplished manually or the frame 110 may be mobile, cleaning the vessel 102 interior while automatically moving from one location to the next in predetermined or random fashion by means of pre-assembled guides for the frame 110 and operated from outside of the vessel by the control system 118.

The acoustic cleaning device 106 inside the vessel direct acoustic waves 120 throughout the cleaning solution 114 and onto the interior surfaces of the vessel 102. In this manner, acoustic cavitations and vibrations are produced by the pressure variations in sound waves 120 moving through the cleaning solution 114 and a cleaning action is accomplished throughout the vessel 102 interior. One skilled in the art will understand that the wavelengths and frequencies are set based on the cleaning needs, for example the size of the vessel, type of substances being cleaned, vessel surface materials, cleaning time requirements or limitations, cleaning solution being used, and the like.

Even though many of the examples discussed herein are applications of the present invention in cleaning a vessel, the present invention also can be applied to other types of removable industrial equipment in which the equipment is placed in a vessel to be cleaned using the acoustic cleaning device and method.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

It should be apparent from the foregoing that an invention having significant advantages has been provided.

What is claimed is:

1. An acoustic cleaning device, comprising:
an acoustic transducer;
a frame to which the acoustic transducer is removably attached thereto, wherein the frame is removably attached to the interior of a vessel; and
an ultrasonic generator that powers the acoustic transducer which, in turn, produces agitation in a cleaning solution so as to clean the interior of the vessel.

2. The acoustic cleaning device of claim 1, wherein a control system is included to control the ultrasonic generator.

3. The acoustic cleaning device of claim 1, wherein the frame includes a rail to which the frame is movably attached such that the frame can be moved along the rail within the vessel to change the location or direction of the agitation produced by the acoustic transducer.

4. The acoustic cleaning device of claim 2, wherein the frame includes a rail to which the frame is movably attached such that the frame, with acoustic transducer removably attached, can be moved along the rail within the vessel to change the location or direction of the agitation produced by the acoustic transducer.

5. The acoustic cleaning device of claim 4, wherein the frame is moved along the rail within the vessel by the automated control system.

6. The acoustic cleaning device of claim 1, wherein the acoustic transducer is housed in stainless steel and includes flanges for mounting to the frame as well as a piezoelectric driving element that is attached to a radiating diaphragm.

7. The acoustic cleaning device of claim 5, wherein the acoustic transducer also includes a bleed resistor wired in parallel to the piezoelectric driving element to prevent electrical charge buildup in the acoustic transducer.

8. The acoustic cleaning device of claim 1, wherein the acoustic transducer is one of a plurality of acoustic transducers, each of which are supported by a frame.

9. The acoustic cleaning device of claim 1, wherein removable equipment needing to be cleaned is placed into the vessel.

10. An acoustic cleaning device, comprising:
a frame, wherein the frame is removably fixed to the interior of a vessel;
an acoustic transducer which is removably attached to the frame, wherein the acoustic transducer is housed in stainless steel and includes flanges for mounting the acoustic transducer to the frame as well as a piezoelectric driving element that is attached to a radiating diaphragm;
an ultrasonic generator that powers the acoustic transducer which, in turn, produces agitation in a cleaning solution so as to clean the interior of the vessel; and
a control system to control the ultrasonic generator.

11. The acoustic cleaning device of claim 10, wherein the frame includes a rail to which the frame, with acoustic transducer removably attached to the frame, is movably attached such that the frame can be moved along the rail within the vessel to change the location or direction of the agitation produced by the acoustic transducer.

12. The acoustic cleaning device of claim 11, wherein the frame is moved along the rail within the vessel by the automated control system.

13. The acoustic cleaning device of claim 10, wherein the acoustic transducer also includes a bleed resistor wired in parallel to the piezoelectric driving element to prevent electrical charge buildup in the acoustic transducer.

14. The acoustic cleaning device of claim 10, wherein the acoustic transducer is one of a plurality of acoustic transducers, each of which are removably attached to a frame.

15. The acoustic cleaning device of claim 10, wherein removable equipment needing to be cleaned is placed into the vessel.

16. A method for cleaning a vessel with an acoustic cleaning device, the method comprising:
Providing an acoustic cleaning device, the acoustic cleaning device comprising an acoustic transducer, a frame to which the acoustic transducer can be removably attached thereto, an ultrasonic generator electrically connected to the acoustic transducer, and control system for controlling the ultrasonic generator;
removably attaching the acoustic transducer to the frame;
positioning the frame with removably attached acoustic transducer inside a vessel at a desired location and removably attaching the frame to the interior of the vessel;
filling the vessel with a cleaning solution;
sealing the vessel;
inputting specifications for the ultrasonic generator into the control system; and
powering the acoustic transducer with the ultrasonic generator to produce agitation in the cleaning solution so as to clean the interior of the vessel.

17. The method for cleaning a vessel with an acoustic cleaning device of claim 16, wherein the acoustic transducer is one of a plurality of acoustic transducers, each of which are removably attached to a frame.

18. The method for cleaning a vessel with an acoustic cleaning device of claim 16, wherein the frame includes a rail along which the frame can move, and following the powering step, moving the frame to a second desired location for additional cleaning.

19. The method for cleaning a vessel with an acoustic cleaning device of claim 18, wherein the control system also controls the position of the frame along the rail, and included in the inputting step, inputting specifications for the location and direction of the frame in the control system.

20. The method for cleaning a vessel with an acoustic cleaning device of claim 19, wherein following the powering step, the control system moves the frame to a second desired location for additional cleaning.

21. The method for cleaning a vessel with an acoustic cleaning device of claim 16, wherein before the positioning step, removable equipment needing to cleaned is placed into the vessel.
